(19) United States
(12) Patent Application Publication
(10) Pub. No.: US 2026/0145488 A1
(43) Pub. Date: May 28, 2026

(54) VEHICULAR REFRIGERATION CYCLE UNIT

(71) Applicant: MITSUBISHI HEAVY INDUSTRIES THERMAL SYSTEMS, LTD., Tokyo (JP)

(72) Inventors: Katsuhiro SAITO, Tokyo (JP); Takayuki KOBAYASHI, Tokyo (JP); Nobuya NAKAGAWA, Tokyo (JP); Hideto NOYAMA, Tokyo (JP); Masatoshi MORISHITA, Tokyo (JP); Hirotaka TANABE, Tokyo (JP); Hirofumi HIRATA, Tokyo (JP); Shinya HAMAMOTO, Tokyo (JP)

(73) Assignee: MITSUBISHI HEAVY INDUSTRIES THERMAL SYSTEMS, LTD., Tokyo (JP)

(21) Appl. No.: 18/706,322

(22) PCT Filed: Nov. 4, 2021
(86) PCT No.: PCT/JP2021/040595

§ 371 Date: Apr. 30, 2024

(51) Int. Cl. B60H 1/32

(52) U.S. Cl. CPC B60H 1/32284; B60H 1/3223; B60H 1/3227

(57) ABSTRACT

Provided is a vehicular refrigeration cycle unit that is interposed between a vehicle-exterior heat exchanger and a vehicle-interior heat exchanger and that exchanges heat between secondary refrigerants respectively flowing through the vehicle-exterior heat exchanger and the vehicle-interior heat exchanger. The vehicular refrigeration cycle unit includes a base portion and a refrigeration cycle fixed to a main surface of the base portion and including a compressor, a condenser, an expansion valve, and an evaporator connected sequentially by pipes through which a primary refrigerant flows, and the compressor, the condenser, and the evaporator are fixed on the base portion so that the lengthwise directions thereof match.

### TECHNICAL FIELD

The present disclosure relates to a vehicular refrigeration cycle unit.

### BACKGROUND ART

Patent Document 1 discloses a refrigeration cycle that includes a compressor, a heat medium cooler (evaporator), and a heat medium heater (condenser) accommodated in a case having thermal insulating properties and constitutes a vehicular heat management system.

### CITATION LIST

### Patent Literature

Patent Document 1: JP 2014-201224 A

### SUMMARY OF INVENTION

### Technical Problem

In the refrigeration cycle described in Patent Document 1, the compressor, the evaporator, and the condenser are arranged side by side in a row in the case. For example, in a case where the compressor, the evaporator, and the condenser are horizontally arranged such that the longitudinal direction of each of the compressor, the evaporator, and the condenser coincides with the horizontal direction, there is a problem in that a space occupied by the refrigeration cycle constituted by the compressor, the evaporator, and the condenser increases.

The present disclosure has been made to solve the above-described problem, and an object of the present disclosure is to provide a vehicular refrigeration cycle unit that can suppress an increase in a space occupied by a refrigeration cycle.

### Solution to Problem

In order to solve the above-described problem, a vehicular refrigeration cycle unit according to the present disclosure is a vehicular refrigeration cycle unit that is interposed between a vehicle-exterior heat exchanger and a vehicle-interior heat exchanger and that exchanges heat between secondary refrigerants respectively flowing through the vehicle-exterior heat exchanger and the vehicle-interior heat exchanger. The vehicular refrigeration cycle unit includes a base portion and a refrigeration cycle fixed to a main surface of the base portion. The refrigeration cycle includes a compressor, a condenser, an expansion valve, and an evaporator connected sequentially by pipes through which a primary refrigerant flows. The compressor, the condenser, and the evaporator are fixed on the base portion such that the longitudinal directions thereof coincide with each other.

### Advantageous Effects of Invention

According to the present disclosure, a vehicular refrigeration cycle unit that can suppress an increase in a space occupied by a refrigeration cycle can be provided.

### BRIEF DESCRIPTION OF DRAWINGS

FIG. 1 is a system diagram illustrating a configuration of a vehicular air conditioning device (during a heating operation) according to a first embodiment.

FIG. 2 is a perspective view of a vehicular refrigeration cycle unit according to the first embodiment.

FIG. 3 is a plan view of the vehicular refrigeration cycle unit according to the first embodiment.

FIG. 4 is a partial cross-sectional view illustrating a configuration of a heat exchanging unit of an evaporator according to the first embodiment.

FIG. 5 is a partial cross-sectional view illustrating a configuration of a heat exchanging unit of a condenser according to the first embodiment.

FIG. 6 is a perspective view of a vehicular refrigeration cycle unit according to a second embodiment.

FIG. 7 is a plan view of the vehicular refrigeration cycle unit according to the second embodiment.

FIG. 8 is a system diagram illustrating a configuration of a vehicular air conditioning device (during a cooling operation) according to an embodiment.

### DESCRIPTION OF EMBODIMENTS

Hereinafter, a vehicular air conditioning device according to an embodiment of the present disclosure will be described with reference to the drawings.

### First Embodiment

### Vehicular Air Conditioning Device

A vehicular air conditioning device 1 is a device that is mounted on an electric vehicle or the like and conditions air in a vehicle body C. A temperature difference between the inside and outside of the vehicle body C is regulated by the vehicular air conditioning device 1. In the present embodiment, a configuration in which the vehicular air conditioning device 1 performs a heating operation will be described as an example.

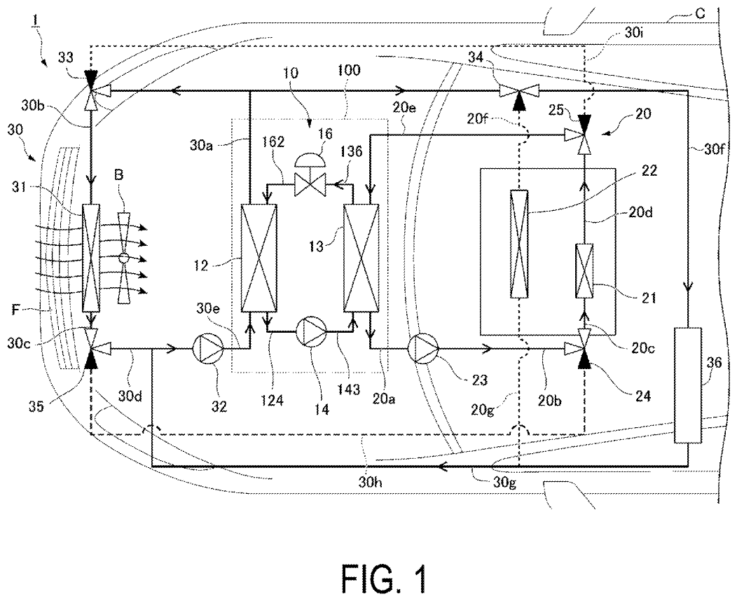

As illustrated in FIG. 1, a vehicular air conditioning device 1 includes a vehicular refrigeration cycle unit 100, a vehicle-interior heat medium circuit 20, and a vehicle-exterior heat medium circuit 30.

In the drawings, among various lines (pipes) included in the vehicular refrigeration cycle unit 100, the vehicle-interior heat medium circuit 20, and the vehicle-exterior heat medium circuit 30, lines in an open state through which a refrigerant can flow are indicated by solid lines, and lines in a closed state through which a refrigerant cannot flow are indicated by broken lines. In addition, among the various valves, valves in black indicate a closed state, and valves in white indicate an open state.

### Vehicular Refrigeration Cycle Unit

The vehicular refrigeration cycle unit 100 is a device for circulating a primary refrigerant R1 that exchanges heat with a secondary refrigerant R2 used for in-vehicle air conditioning. As the primary refrigerant R1 in the present embodiment, for example, an R290 refrigerant (propane) which is highly flammable hydrocarbon is employed.

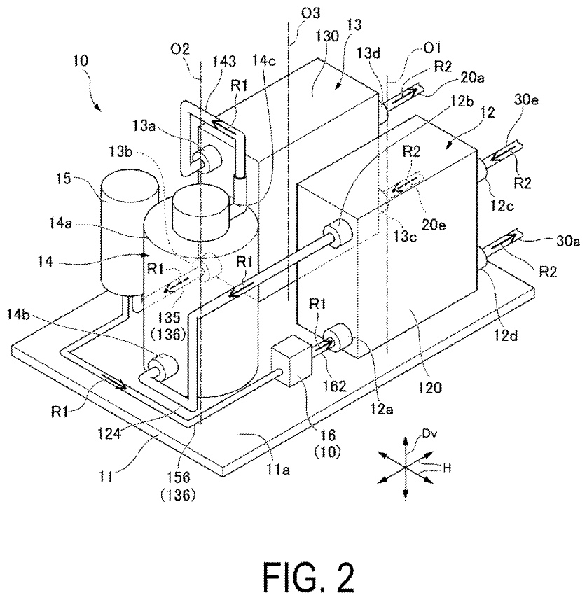

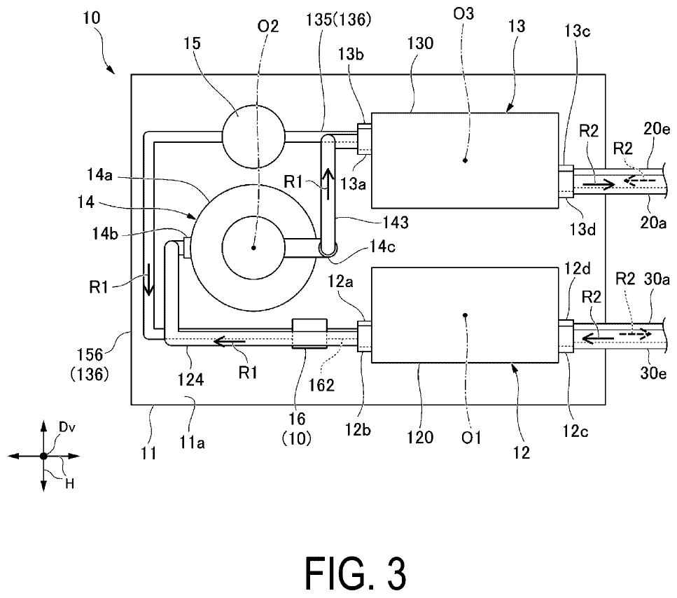

As illustrated in FIGS. 2 and 3, the vehicular refrigeration cycle unit 100 includes a base portion 11, a refrigeration cycle 10, and various lines (a suction line 124, a discharge line 143, a pre-expansion line 136, and a post-expansion line 162).

### Base Portion

The base portion 11 is a plate having a flat plate shape. The base portion 11 includes a main surface 11a facing upward in a vertical direction Dy which is a direction coinciding with the gravitational direction. In other words, the base portion 11 extends in a horizontal direction H perpendicular to the vertical direction Dv such that the main surface 11a faces upward. For example, a metal is employed as a material constituting the base portion 11.

### Refrigeration Cycle

The refrigeration cycle 10 includes a plurality of devices that realize a thermodynamic cycle. The refrigeration cycle 10 is a refrigerant circuit in which, in order to cause the primary refrigerant R1 serving as a heat medium to exchange heat with the secondary refrigerant R2, the primary refrigerant R1 sequentially flows and circulates through the plurality of devices while being repeatedly compressed and expanded, and evaporated and condensed.

The refrigeration cycle 10 includes an evaporator 12, a compressor 14, a condenser 13, a receiver 15, and an expansion valve 16. These components are sequentially connected by pipes through which the primary refrigerant R1 flows.

### Evaporator

The evaporator 12 is a plate-type heat exchanger that evaporates (gasifies) the primary refrigerant R1 by heat exchange between the primary refrigerant R1 sequentially flowing through the refrigeration cycle 10 and the secondary refrigerant R2 introduced from the outside of the vehicular refrigeration cycle unit 100. The primary refrigerant R1 in the evaporator 12 is heated by the secondary refrigerant R2 while simultaneously cooling the secondary refrigerant R2. The evaporator 12 is fixed to the main surface 11a of the base portion 11.

The evaporator 12 includes a heat exchanging unit 120, a primary refrigerant inlet section 12a, a primary refrigerant outlet section 12b, a secondary refrigerant inlet section 12c, and a secondary refrigerant outlet section 12d.

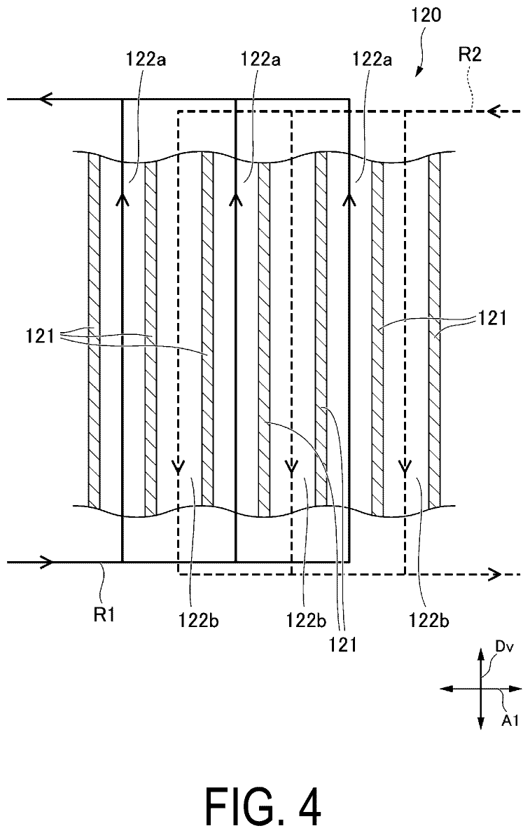

As illustrated in FIG. 4, the heat exchanging unit 120 exchanges heat between the primary refrigerant R1 and the secondary refrigerant R2. The heat exchanging unit 120 includes a plurality of evaporator plates 121 extending in a flat plate shape. The plurality of evaporator plates 121 are arranged in a row in the horizontal direction H so as to be stacked with a gap therebetween. Hereinafter, a direction in which the evaporator plates 121 are arranged is referred to as an “arrangement direction A1”. The evaporator plate 121 has a rectangular shape when viewed in the arrangement direction A1.

As a material constituting the evaporator plate 121, for example, stainless steel or titanium is employed.

The longitudinal direction of each evaporator plate 121 coincides with the vertical direction Dv. Corresponding sides of a pair of evaporator plates 121 adjacent to each other in the arrangement direction A1 are sealed with no space therebetween by brazing using a brazing material such as copper or nickel. Thus, the plurality of evaporator plates 121 are integrally formed, and heat exchange flow paths 122a and 122b extending in the vertical direction Dv are formed between a pair of evaporator plates 121 adjacent to each other.

Therefore, a plurality of heat exchange flow paths 122a and a plurality of heat exchange flow paths 122b are formed in the heat exchanging unit 120, and these heat exchange flow paths 122a and 122b are arranged in the horizontal direction H. In the plurality of heat exchange flow paths 122a and 122b, the heat exchange flow path 122a through which only the primary refrigerant R1 flows and the heat exchange flow path 122b through which only the secondary refrigerant R2 flows are alternately repeated in the arrangement direction A1 of the evaporator plates 121. The heat exchange flow paths 122a through which the primary refrigerant R1 flows communicate with each other, the heat exchange flow paths 122b through which the secondary refrigerant R2 flows communicate with each other, and the heat exchange flow paths 122a and the heat exchange flow paths 122b do not communicate with each other.

The primary refrigerant R1 introduced into the heat exchanging unit 120 flows through the heat exchange flow paths 122a from a lower side to an upper side in the vertical direction Dv, and the secondary refrigerant R2 flows through the heat exchange flow paths 122b from the upper side to the lower side in the vertical direction Dv. While the primary refrigerant R1 and the secondary refrigerant R2 flow through the heat exchange flow paths 122a and 122b, heat is exchanged between the primary refrigerant R1 and the secondary refrigerant R2 via the evaporator plates 121. That is, heat of the secondary refrigerant R2 is transferred from the heat exchange flow paths 122b through which the secondary refrigerant R2 flows to the heat exchange flow paths 122a through which the primary refrigerant R1 flows via the evaporator plates 121. As a result, the primary refrigerant R1 is evaporated in the heat exchange flow paths 122a as it goes toward the upper side in the vertical direction Dv. That is, the primary refrigerant R1 passes through the heat exchange flow paths 122a to become a gas.

As illustrated in FIGS. 2 and 3, an outer shell of the heat exchanging unit 120 constituted by the plurality of evaporator plates 121 has a cuboid shape. The heat exchanging unit 120 is fixed to the main surface 11a of the base portion 11 so as to extend from the main surface 11a around an evaporator axis O1 which is a virtual axis extending from the main surface 11a of the base portion 11 in a direction coinciding with the vertical direction Dv. That is, the heat exchanging unit 120 is provided at the main surface 11a of the base portion 11 such that the longitudinal direction of the heat exchanging unit 120 coincides with the vertical direction Dv. In other words, the heat exchanging unit 120 is provided in a cantilevered manner with respect to the main surface 11a of the base portion 11.

The primary refrigerant inlet section 12a is an inlet section for causing the primary refrigerant R1 to flow into the heat exchange flow paths 122a in the heat exchanging unit 120. The primary refrigerant inlet section 12a is provided, for example, at a portion on the lower side in the vertical direction Dv of the evaporator plate 121 disposed on one side in the arrangement direction A1.

The primary refrigerant outlet section 12b is an outlet section for causing the primary refrigerant R1 heated and evaporated in the heat exchange flow paths 122a to flow out of the heat exchanging unit 120. The primary refrigerant outlet section 12b is provided, for example, at a portion on the upper side in the vertical direction Dv of the evaporator plate 121 disposed on one side in the arrangement direction A1.

The secondary refrigerant inlet section 12c is an inlet section for causing the secondary refrigerant R2 to flow into the heat exchange flow paths 122b in the heat exchanging unit 120. The secondary refrigerant inlet section 12c is provided, for example, at a portion on the upper side in the vertical direction Dv of the evaporator plate 121 disposed on one side in the arrangement direction A1.

The secondary refrigerant outlet section 12d is an outlet section for causing the secondary refrigerant R2 heated and evaporated in the heat exchange flow paths 122b to flow out of the heat exchanging unit 120. The secondary refrigerant outlet section 12d is provided, for example, at a portion on the lower side in the vertical direction Dv of the evaporator plate 121 disposed on one side in the arrangement direction A1.

### Compressor

The compressor 14 is a device that compresses the primary refrigerant R1 having been gasified by passing through the evaporator 12. The pressure of the primary refrigerant R1 introduced into the compressor 14 is increased through compression by the compressor 14 to a predetermined pressure higher than the pressure before the compression. As a result, the temperature of the primary refrigerant R1 becomes higher than before the compression.

The compressor 14 is fixed to the main surface 11a of the base portion 11. The compressor 14 and the evaporator 12 are connected to each other by the suction line 124. That is, one end of the suction line 124 is connected to the primary refrigerant outlet section 12b of the evaporator 12, and the other end of the suction line 124 is connected to a suction port 14b of the compressor 14.

The compressor 14 includes a compressor casing 14a, the suction port 14b, and a discharge port 14c.

The compressor casing 14a has a tube shape. The compressor casing 14a is fixed to the main surface 11a of the base portion 11 so as to extend from the main surface 11a around a compressor axis O2 which is a virtual axis extending from the main surface 11a of the base portion 11 in a direction coinciding with the vertical direction Dv. In other words, the compressor casing 14a is provided in a cantilevered manner with respect to the main surface 11a of the base portion 11.

The compressor 14 in the present embodiment is a so-called vertical scroll compressor. The compressor casing 14a is formed therein with a refrigerant compression mechanism (not illustrated) which includes a fixed scroll (not illustrated) and an orbiting scroll (not illustrated) and in which a compression chamber for compressing the primary refrigerant R1 is defined by the fixed scroll and the orbiting scroll.

The compression chamber is provided on the upper side in the vertical direction Dv in the compressor casing 14a.

A rotor shaft for rotating the orbiting scroll of the refrigerant compression mechanism is provided so as to extend in the vertical direction Dv inside the compressor casing 14a.

The suction port 14b is a refrigerant inlet section for introducing the primary refrigerant R1 into the refrigerant compression mechanism inside the compressor casing 14a. The suction port 14b is provided at an end portion on the lower side in the vertical direction Dv of an outer surface of the compressor casing 14a. The primary refrigerant R1 is introduced into the compressor casing 14a through the suction port 14b.

The discharge port 14c is a refrigerant outlet section for discharging the primary refrigerant R1 from the compressor casing 14a. The discharge port 14c is provided at an end portion on the upper side in the vertical direction Dv of an outer surface of the compressor casing 14a. The primary refrigerant R1 is discharged to the outside of the compressor casing 14a through the discharge port 14c.

### Condenser

The condenser 13 is a plate-type heat exchanger that condenses (liquefies) the primary refrigerant R1 by heat exchange between the primary refrigerant R1, which has a higher temperature and a higher pressure than before being compressed by passing through the compressor 14, and the secondary refrigerant R2 introduced from the outside of the vehicular refrigeration cycle unit 100. The primary refrigerant R1 in the condenser 13 is cooled by the secondary refrigerant R2 while simultaneously heating the secondary refrigerant R2. The condenser 13 is fixed to the main surface 11a of the base portion 11.

The condenser 13 includes a heat exchanging unit 130, a primary refrigerant inlet section 13a, a primary refrigerant outlet section 13b, a secondary refrigerant inlet section 13c, and a secondary refrigerant outlet section 13d.

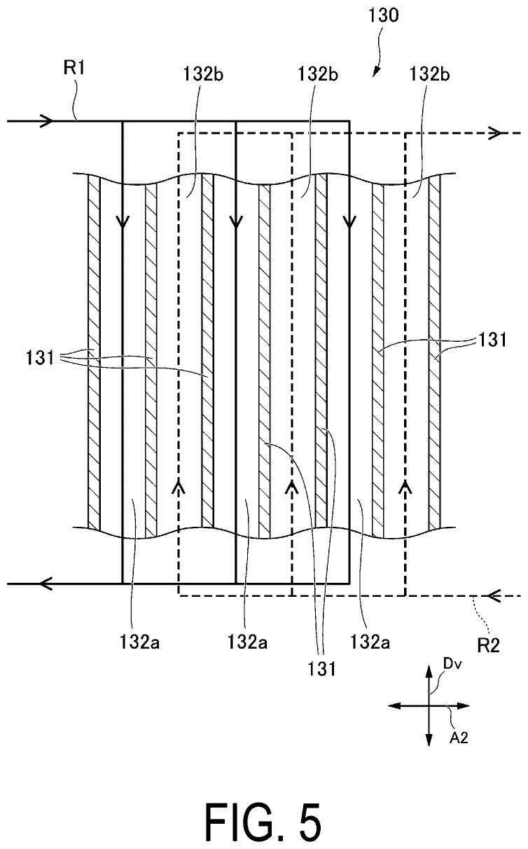

As illustrated in FIG. 5, the heat exchanging unit 130 exchanges heat between the primary refrigerant R1 and the secondary refrigerant R2. The heat exchanging unit 130 includes a plurality of condenser plates 131 extending in a flat plate shape. The plurality of condenser plates 131 are arranged in a row in the horizontal direction H so as to be stacked with a gap therebetween. Hereinafter, a direction in which the condenser plates 131 are arranged is referred to as an “arrangement direction A2”. The condenser plate 131 has a rectangular shape when viewed in the arrangement direction A2.

As a material constituting the condenser plate 131, for example, stainless steel or titanium is employed.

The longitudinal direction of each condenser plate 131 coincides with the vertical direction Dv. Corresponding sides of a pair of condenser plates 131 adjacent to each other in the arrangement direction A2 are sealed with no space therebetween by brazing using a brazing material such as copper or nickel.

Thus, the plurality of condenser plates 131 are integrally formed, and heat exchange flow paths 132a and 132b extending in the vertical direction Dv are formed between a pair of condenser plates 131 adjacent to each other.

Therefore, a plurality of heat exchange flow paths 132a and a plurality of heat exchange flow paths 132b are formed in the heat exchanging unit 130, and these heat exchange flow paths 132a and 132b are arranged in the horizontal direction H. In the plurality of heat exchange flow paths 132a and 132b, the heat exchange flow path 132a through which only the primary refrigerant R1 flows and the heat exchange flow path 132b through which only the secondary refrigerant R2 flows are alternately repeated in the arrangement direction A2 of the condenser plates 131. The heat exchange flow paths 132a through which the primary refrigerant R1 flows communicate with each other, the heat exchange flow paths 132b through which the secondary refrigerant R2 flows communicate with each other, and the heat exchange flow paths 132a and the heat exchange flow paths 132b do not communicate with each other.

The primary refrigerant R1 introduced into the heat exchanging unit 130 flows through the heat exchange flow paths 132a from the upper side to the lower side in the vertical direction Dv, and the secondary refrigerant R2 flows through the heat exchange flow paths 132b from the lower side to the upper side in the vertical direction Dv. While the primary refrigerant R1 and the secondary refrigerant R2 flow through the heat exchange flow paths 132a and 132b, heat is exchanged between the primary refrigerant R1 and the secondary refrigerant R2 via the condenser plates 131. That is, heat of the primary refrigerant R1 is transferred from the heat exchange flow paths 132a through which the primary refrigerant R1 flows to the heat exchange flow paths 132b through which the secondary refrigerant R2 flows via the condenser plates 131. As a result, the primary refrigerant R1 is condensed in the heat exchange flow paths 132a as it goes toward the lower side in the vertical direction Dv. The primary refrigerant R1 passes through the heat exchange flow paths 132a to become a fluid in a liquid state.

As illustrated in FIGS. 2 and 3, an outer shell of the heat exchanging unit 130 constituted by the plurality of condenser plates 131 has a cuboid shape. The heat exchanging unit 130 is fixed to the main surface 11a of the base portion 11 so as to extend from the main surface 11a around a condenser axis O3 which is a virtual axis extending from the main surface 11a of the base portion 11 in a direction coinciding with the vertical direction Dv. That is, the heat exchanging unit 130 is provided at the main surface 11a of the base portion 11 such that the longitudinal direction of the heat exchanging unit 130 coincides with the vertical direction Dv. In other words, the heat exchanging unit 130 is provided in a cantilevered manner with respect to the main surface 11a of the base portion 11.

The primary refrigerant inlet section 13a is an inlet section for causing the primary refrigerant R1 to flow into the heat exchange flow paths 132a in the heat exchanging unit 130. The primary refrigerant inlet section 13a is provided, for example, at a portion on the upper side in the vertical direction Dv of the condenser plate 131 disposed on one side in the arrangement direction A2.

The primary refrigerant outlet section 13b is an outlet section for causing the primary refrigerant R1 cooled and condensed in the heat exchange flow paths 132a to flow out of the heat exchanging unit 130. The primary refrigerant outlet section 13b is provided, for example, at a portion on the lower side in the vertical direction Dv of the condenser plate 131 disposed on the one side in the arrangement direction A2.

The secondary refrigerant inlet section 13c is an inlet section for causing the secondary refrigerant R2 to flow into the heat exchange flow paths 132b in the heat exchanging unit 130. The secondary refrigerant inlet section 13c is provided, for example, at a portion on the lower side in the vertical direction Dv of the condenser plate 131 disposed on the other side in the arrangement direction A2.

The secondary refrigerant outlet section 13d is an outlet section for causing the secondary refrigerant R2 heated in the heat exchange flow paths 132b to flow out of the heat exchanging unit 130. The secondary refrigerant outlet section 13d is provided, for example, at a portion on the upper side in the vertical direction Dv of the condenser plate 131 disposed on the other side in the arrangement direction A2.

The condenser 13 and the compressor 14 are connected to each other by the discharge line 143. That is, one end of the discharge line 143 is connected to the discharge port 14c of the compressor 14, and the other end of the discharge line 143 is connected to the primary refrigerant inlet section 13a of the condenser 13.

As described above, the compressor 14, the condenser 13, and the evaporator 12 are fixed on the base portion 11 such that the longitudinal directions thereof coincide with each other. Thus, the compressor 14, the condenser 13, and the evaporator 12 have the same orientation on the base portion 11.

### Receiver

The receiver 15 is a gas-liquid separator that receives the primary refrigerant R1 having become a fluid in a liquid state by passing through the condenser 13, separates the primary refrigerant R1 into a gas phase and a liquid phase, and temporarily retains the gas phase and the liquid phase therein.

The receiver 15 and the condenser 13 are connected to each other by a first line 135 of the pre-expansion line 136. That is, one end of the first line 135 is connected to a primary refrigerant outlet section 13b of the condenser 13, and the other end of the first line 135 is connected to a refrigerant inlet section located at a lower end of the receiver 15. The receiver 15 is supported from the lower side in the vertical direction Dv by the first line 135 connected to the condenser 13, and is supported (held) at a position separated from the main surface 11a of the base portion 11 as illustrated in FIG. 2.

The primary refrigerant R1 in the gas-liquid mixed state and introduced into the receiver 15 flows into the liquid phase portion retained in the receiver 15. The liquid portion of the primary refrigerant R1 thus introduced is added to the liquid phase, and the remaining gas portion becomes bubbles, moves upward inside the receiver 15, and is added to the gas phase. The primary refrigerant R1 retained as the liquid phase inside the receiver 15 is discharged to the outside of the receiver 15. Accordingly, the primary refrigerant R1 in a liquid state is constantly supplied from the receiver 15.

### Expansion Valve

The expansion valve 16 is a device that receives the primary refrigerant R1, which has entered a liquid state by passing through the receiver 15, and adiabatically expands the primary refrigerant R1. The expansion valve 16 and the receiver 15 are connected to each other by a second line 156 of the pre-expansion line 136. That is, one end of the second line 156 is connected to a refrigerant outlet section of the receiver 15, and the other end of the second line 156 is connected to the expansion valve 16.

The pressure of the primary refrigerant R1 introduced into the expansion valve 16 is decreased by an expansion effect of the expansion valve 16 to a predetermined pressure lower than before the expansion. As a result, the temperature of the primary refrigerant R1 becomes lower than before the expansion. Specifically, the primary refrigerant R1 having passed through the expansion valve 16 becomes a fluid in a gas-liquid mixed state and the temperature of the primary refrigerant R1 is decreased to a temperature lower than the temperature of the secondary refrigerant R2 that is a heat-exchange destination.

The expansion valve 16 and the evaporator 12 are connected to each other by the post-expansion line 162, and the primary refrigerant R1 having passed through the expansion valve 16 is introduced into the evaporator 12 through the post-expansion line 162. That is, one end of the post-expansion line 162 is connected to the expansion valve 16, and the other end of the post-expansion line 162 is connected to a primary refrigerant inlet section 12a of the evaporator 12. The expansion valve 16 is supported by the post-expansion line 162 connected to the evaporator 12, and is supported (held) at a position separated from the main surface 11a of the base portion 11 as illustrated in FIG. 2.

### Vehicle-Interior Heat Medium Circuit

The vehicle-interior heat medium circuit 20 is a refrigerant circuit through which the secondary refrigerant R2 having exchanged heat with the primary refrigerant R1 in the refrigeration cycle 10 flows and which conditions air in the vehicle interior. As the secondary refrigerant R2 in the present embodiment, for example, an antifreezing fluid such as ethylene glycol is used.

As illustrated in FIG. 1, the vehicle-interior heat medium circuit 20 includes a heater core 21 (vehicle-interior heat exchanger), a cooler core 22 (vehicle-interior heat exchanger), a first pump 23, a first valve 24, a second valve 25, and various lines (a first heat medium line 20a to a seventh heat medium line 20g).

The heater core 21 and the cooler core 22 are heat exchangers for causing indoor air inside the vehicle body C and outdoor air outside the vehicle body C to exchange heat with the secondary refrigerant R2. The secondary refrigerant R2 having passed through the condenser 13 of the vehicular refrigeration cycle unit 100 is introduced into the heater core 21. In the process of introducing the secondary refrigerant R2 from the condenser 13 to the heater core 21, the secondary refrigerant R2 passes through the first pump 23 and the first valve 24.

The first pump 23 is a pump that pumps the secondary refrigerant R2 condensed by the condenser 13 to the heater core 21. The first heat medium line 20a serving as a flow path for suctioning the secondary refrigerant R2 into the first pump 23 connects the condenser 13 and the first pump 23. That is, one end of the first heat medium line 20a is connected to the secondary refrigerant outlet section 13d of the condenser 13, and the other end of the first heat medium line 20a is connected to a refrigerant suction port of the first pump 23.

The second heat medium line 20b serving as a flow path for discharging the secondary refrigerant R2 from the first pump 23 toward the heater core 21 connects the first pump 23 and the first valve 24. That is, one end of the second heat medium line 20b is connected to a refrigerant discharge port of the first pump 23, and the other end of the second heat medium line 20b is connected to the first valve 24. The first valve 24 is a three-way valve that can change the flow path (destination) of the secondary refrigerant R2.

The first valve 24 and the heater core 21 are connected by the third heat medium line 20c. That is, one end of the third heat medium line 20c is connected to the first valve 24, and the other end of the third heat medium line 20c is connected to the heater core 21.

The secondary refrigerant R2 introduced into the heater core 21 is cooled by exchanging heat with the indoor air of the vehicle body C and the outdoor air introduced into the vehicle body C while heating the indoor air and the outdoor air. Thus, the air in the vehicle body C can be heated. As the outdoor air, outside air outside the vehicle body C introduced by a blower B via a front grille F located on the front side in the travel direction of the vehicle body C is used.

The secondary refrigerant R2 cooled in the heater core 21 is returned to the condenser 13 via the second valve 25. The second valve 25 is a three-way valve that can change the flow path (destination) of the secondary refrigerant R2. The first valve 24 and the heater core 21 are connected by the fourth heat medium line 20d. That is, one end of the fourth heat medium line 20d is connected to a refrigerant outlet section of the heater core 21, and the other end of the fourth heat medium line 20d is connected to the second valve 25.

The second valve 25 and the condenser 13 are connected by the fifth heat medium line 20e. That is, one end of the fifth heat medium line 20e is connected to the second valve 25, and the other end of the fifth heat medium line 20e is connected to the secondary refrigerant inlet section 13c of the condenser 13.

With the configuration described above, the secondary refrigerant R2 sequentially flows through the condenser 13, the first pump 23, and the heater core 21, and returns to the condenser 13. By repeating this circulation, the heating operation is achieved, and the temperature inside the vehicle can be continuously heated.

The cooler core 22 is provided in the vehicle body C independently of the heater core 21. During the cooling operation, the secondary refrigerant R2 having passed through the evaporator 12 is introduced into the cooler core 22 so as to exchange heat between the secondary refrigerant R2 and outside air.

The flow of the secondary refrigerant R2 during the cooling operation will be described below.

### Vehicle-Exterior Heat Medium Circuit

The vehicle-exterior heat medium circuit 30 is a refrigerant circuit through which the secondary refrigerant R2 having exchanged heat with the primary refrigerant R1 in the refrigeration cycle 10 flows and which cools a battery that powers the vehicle body.

The vehicle-exterior heat medium circuit 30 includes a vehicle-exterior heat exchanger 31, a second pump 32, various valves (a third valve 33 to a fifth valve 35), a battery cooler 36, and various lines (an eighth heat medium line 30a to a twelfth heat medium line 30e, and a first connection line 30f to a fourth connection line 30i).

The vehicle-exterior heat exchanger 31 is a heat exchanger for exchanging heat between outdoor air and the secondary refrigerant R2. A part of the secondary refrigerant R2 having passed through the evaporator 12 of the vehicular refrigeration cycle unit 100 is introduced into the vehicle-exterior heat exchanger 31 via the third valve 33. The remaining part of the secondary refrigerant R2 having passed through the evaporator 12 is introduced into the battery cooler 36 via the fourth valve 34.

The evaporator 12 is connected to the third valve 33 and the fourth valve 34 by the eighth heat medium line 30a. Specifically, one end of the eighth heat medium line 30a is connected to a secondary refrigerant outlet section 12d of the evaporator 12, and the other end of the eighth heat medium line 30a is branched in two directions partway along the eighth heat medium line 30a and connected to the third valve 33 and the fourth valve 34, respectively. The third valve 33 and the fourth valve 34 are three-way valves that can change the flow path (destination) of the secondary refrigerant R2.

The third valve 33 and the vehicle-exterior heat exchanger 31 are connected by a ninth heat medium line 30b. That is, one end of the ninth heat medium line 30b is connected to the third valve 33, and the other end of the ninth heat medium line 30b is connected to a refrigerant inlet section of the vehicle-exterior heat exchanger 31.

The secondary refrigerant R2 introduced into the vehicle-exterior heat exchanger 31 through the eighth heat medium line 30a, the third valve 33, and the ninth heat medium line 30b is heated by heat exchange with outdoor air. Accordingly, the secondary refrigerant R2 becomes higher in temperature than the primary refrigerant R1 introduced into the evaporator 12 and can heat the primary refrigerant R1 flowing through the refrigeration cycle 10 in the evaporator 12. Outside air, which is a heat exchange destination of the vehicle-exterior heat exchanger 31, is suctioned from the outside of the vehicle body C via the front grille F by the blower B provided on the front side inside the vehicle body C.

The second pump 32 is a pump that pumps the secondary refrigerant R2 heated by the vehicle-exterior heat exchanger 31 to the evaporator 12. The secondary refrigerant R2 having passed through the vehicle-exterior heat exchanger 31 passes through the fifth valve 35 in the process of being suctioned into the second pump 32. The fifth valve 35 is a three-way valve that can change the flow path (destination) of the secondary refrigerant R2.

The fifth valve 35 and the vehicle-exterior heat exchanger 31 are connected by a tenth heat medium line 30c. That is, one end of the tenth heat medium line 30c is connected to the vehicle-exterior heat exchanger 31, and the other end of the tenth heat medium line 30c is connected to the fifth valve 35.

An eleventh heat medium line 30d serving as a flow path for suctioning the secondary refrigerant R2 into the second pump 32 connects the fifth valve 35 and the second pump 32. That is, one end of the eleventh heat medium line 30d is connected to the fifth valve 35, and the other end of the eleventh heat medium line 30d is connected to the second pump 32.

The second pump 32 and the evaporator 12 are connected by the twelfth heat medium line 30e. That is, one end of the twelfth heat medium line 30e is connected to the second pump 32, and the other end of the twelfth heat medium line 30e is connected to a secondary refrigerant inlet section 12c of the evaporator 12. Thus, the secondary refrigerant R2 pumped by the second pump is introduced into the evaporator 12.

With the configuration described above, the secondary refrigerant R2 sequentially flows through the evaporator 12, the vehicle-exterior heat exchanger 31, and the second pump 32, and returns to the evaporator 12. By repeating this circulation, the primary refrigerant R1 circulating in the refrigeration cycle 10 can be continuously heated by heat exchange in the evaporator 12.

Accordingly, the vehicular refrigeration cycle unit 100 is interposed between the vehicle-exterior heat exchanger 31 and the heater core 21 (vehicle-interior heat exchanger), and exchanges heat between the secondary refrigerant R2 flowing through the vehicle-exterior heat exchanger 31 and the secondary refrigerant R2 flowing through the vehicle-interior heat exchanger.

The battery cooler 36 is a heat exchanger for cooling a battery. The battery cooler 36 is provided inside the vehicle body C. The above-described remaining part of the secondary refrigerant R2 cooled by the evaporator 12 and flowing through the eighth heat medium line 30a is introduced into the battery cooler 36 via the fourth valve 34. The fourth valve 34 and the battery cooler 36 are connected by a first connection line 30f. That is, one end of the first connection line 30f is connected to the fourth valve 34, and the other end of the first connection line 30f is connected to a refrigerant inlet section of the battery cooler 36.

The secondary refrigerant R2 heated by heat exchange with the battery (not illustrated) in the battery cooler 36 is returned to the evaporator 12. The battery cooler 36 and the eleventh heat medium line 30d are connected by the second connection line 30g. Specifically, one end of the second connection line 30g is connected to a refrigerant outlet section of the battery cooler 36, and the other end of the second connection line 30g is connected to a portion of the eleventh heat medium line 30d on the fifth valve 35 side with respect to the second pump 32. Thus, the secondary refrigerant R2 having passed through the battery cooler 36 joins the eleventh heat medium line 30d via the second connection line 30g, and is pumped to the evaporator 12 again by the second pump 32.

The fourth valve 34 and the cooler core 22 are connected by the sixth heat medium line 20f. That is, one end of the sixth heat medium line 20f is connected to the fourth valve 34, and the other end of the sixth heat medium line 20f is connected to a refrigerant inlet section of the heater core 21. The cooler core 22 and the second connection line 30g are connected by the seventh heat medium line 20g. That is, one end of the seventh heat medium line 20g is connected to the cooler core 22, and the other end of the seventh heat medium line 20g is connected to the second connection line 30g. Thus, during the cooling operation of the vehicular air conditioning device 1, the secondary refrigerant R2 having passed through the evaporator 12 can flow into the cooler core 22 via the fourth valve 34.

During the heating operation, the fourth valve 34 causes the secondary refrigerant R2 having flowed in from the eighth heat medium line 30a to flow only to the first connection line 30f without flowing to the sixth heat medium line 20f. That is, the fourth valve 34 does not supply the secondary refrigerant R2 to the cooler core 22, but supplies the secondary refrigerant R2 only to the battery cooler 36.

Further, the first valve 24 and the fifth valve 35 are connected by the third connection line 30h. That is, one end of the third connection line 30h is connected to the first valve 24, and the other end of the third connection line 30h is connected to the fifth valve 35.

During the heating operation, the first valve 24 causes the secondary refrigerant R2 having flowed in from the second heat medium line 20b to flow only to the third heat medium line 20c without flowing to the third connection line 30h. The fifth valve 35 causes the secondary refrigerant R2 having flowed in from the tenth heat medium line 30c to flow only to the eleventh heat medium line 30d without flowing to the third connection line 30h.

The second valve 25 and the third valve 33 are connected by the fourth connection line 30i. That is, one end of the fourth connection line 30i is connected to the second valve 25, and the other end of the fourth connection line 30i is connected to the third valve 33.

During the heating operation, the second valve 25 causes the secondary refrigerant R2 having flowed in from the fourth heat medium line 20d to flow only to the fifth heat medium line 20e without flowing to the fourth connection line 30i. The third valve 33 causes the secondary refrigerant R2 having flowed in from the eighth heat medium line 30a to flow only to the ninth heat medium line 30b without flowing to the fourth connection line 30i.

### Operational Effects

In the vehicular refrigeration cycle unit 100 according to the above-described embodiment, since the compressor 14, the condenser 13, and the evaporator 12 are fixed on the base portion 11 such that the longitudinal directions thereof coincide with each other, the compressor 14, the condenser 13, and the evaporator 12 have the same orientation on the base portion 11.

Thus, in a case where these components are unitized as the refrigeration cycle 10, dead spaces are less likely to be generated, and the overall size of the refrigeration cycle 10 can be made compact. Therefore, an increase in a space occupied by the refrigeration cycle 10 can be suppressed.

The compressor 14, the condenser 13, and the evaporator 12 are fixed on the same base portion 11 and are sequentially connected by the pipes through which the primary refrigerant R1 flows, and thus the refrigeration cycle 10 is integrated by the base portion 11 and the pipes. Since the refrigeration cycle 10 is integrated, for example, even when an excitation force is generated at the compressor 14 along with an operation of compressing the primary refrigerant R1 in the compressor 14, the excitation force can be dispersed over the entire refrigeration cycle 10 without being unevenly distributed in the refrigeration cycle 10. Thus, vibration generated in the refrigeration cycle 10 can be reduced.

In the vehicular refrigeration cycle unit 100 according to the above-described embodiment, since the longitudinal directions of the compressor 14, the condenser 13, and the evaporator 12 extend in the vertical direction Dv from the main surface 11a facing upward of the base portion 11 extending in the horizontal direction H, the compressor 14, the condenser 13, and the evaporator 12 can receive a force of gravity in the longitudinal directions. Thus, a moment is less likely to be applied to the compressor 14, the condenser 13, and the evaporator 12. Therefore, vibration generated in the refrigeration cycle 10 can be further reduced. In addition, an area required for installing the refrigeration cycle 10 on the main surface 11a of the base portion 11 can be reduced.

In the vehicular refrigeration cycle unit 100 according to the above-described embodiment, since the rotor shaft of the compressor 14 is provided so as to extend in the vertical direction Dv, the compressor 14 can receive a force of gravity in the longitudinal direction. Thus, a moment is less likely to be applied to the compressor 14. Therefore, vibration generated from the compressor 14 can be further reduced. In addition, an area required for installing the compressor 14 on the main surface 11a of the base portion 11 can be reduced.

In the vehicular refrigeration cycle unit 100 according to the above-described embodiment, since the heat exchange flow paths 122a, 122b, 132a, and 132b extending in the vertical direction Dv of the condenser 13 and the evaporator 12 are arranged in the horizontal direction H, the primary refrigerant R1 evaporated in the evaporator 12 and the primary refrigerant R1 condensed in the condenser 13 can be smoothly guided in the vertical direction Dv. That is, the primary refrigerant R1 evaporated in the evaporator 12 can be guided to the upper side in the vertical direction Dv, and the primary refrigerant R1 condensed in the condenser 13 can be guided to the lower side in the vertical direction Dv. Thus, smooth phase transition flows of the primary refrigerant R1 can be achieved in the heat exchange flow paths 122a and 132a. Therefore, the performance of the condenser 13 and the evaporator 12 can be suitably exhibited.

### Second Embodiment

A vehicular air conditioning device 1 according to the second embodiment of the present disclosure will be described below. A vehicular refrigeration cycle unit described in the second embodiment is different from the vehicular refrigeration cycle unit of the first embodiment in the arrangement of a receiver included in a refrigeration cycle. The same components as the components in the first embodiment are denoted by the same reference signs, and detailed descriptions thereof are omitted.

### Receiver

A receiver 15a is a gas-liquid separator that receives the primary refrigerant R1 having become a fluid in a liquid state by passing through the condenser 13, separates the primary refrigerant R1 into a gas phase and a liquid phase, and temporarily retains the gas phase and the liquid phase therein.

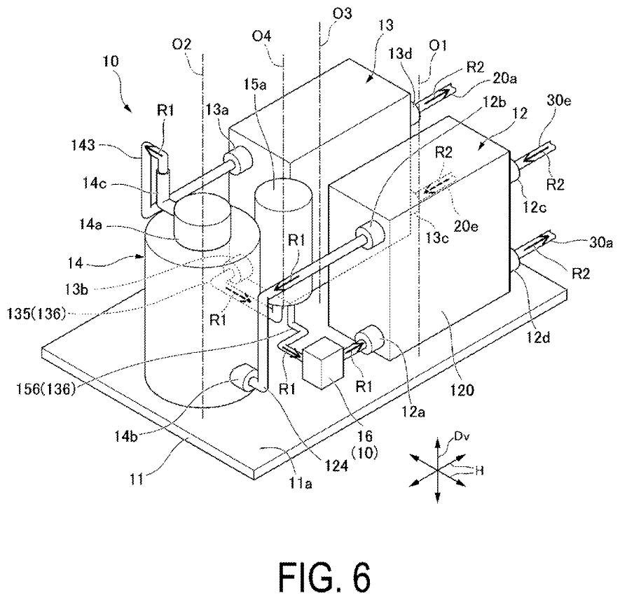

The receiver 15a and the condenser 13 are connected by the first line 135 of the pre-expansion line 136. That is, one end of the first line 135 is connected to the primary refrigerant outlet section 13b of the condenser 13, and the other end of the first line 135 is connected to a refrigerant inlet section located at a lower end of the receiver 15a. The receiver 15a is supported from the lower side in the vertical direction Dv by the first line 135 connected to the condenser 13, and is supported (held) at a position separated from the main surface 11a of the base portion 11 as illustrated in FIG. 6.

The primary refrigerant R1 in the liquid state introduced into the receiver 15a flows into the liquid phase portion stored in the receiver 15a. The liquid portion of the primary refrigerant R1 introduced is added to the liquid phase, and the remaining gas portion becomes bubbles, moves upward inside the receiver 15a, and is added to the gas phase. The primary refrigerant R1 stored as the liquid phase inside the receiver 15a is discharged to the outside of the receiver 15a. Accordingly, the primary refrigerant R1 in the liquid state is always supplied from the receiver 15a to the expansion valve 16.

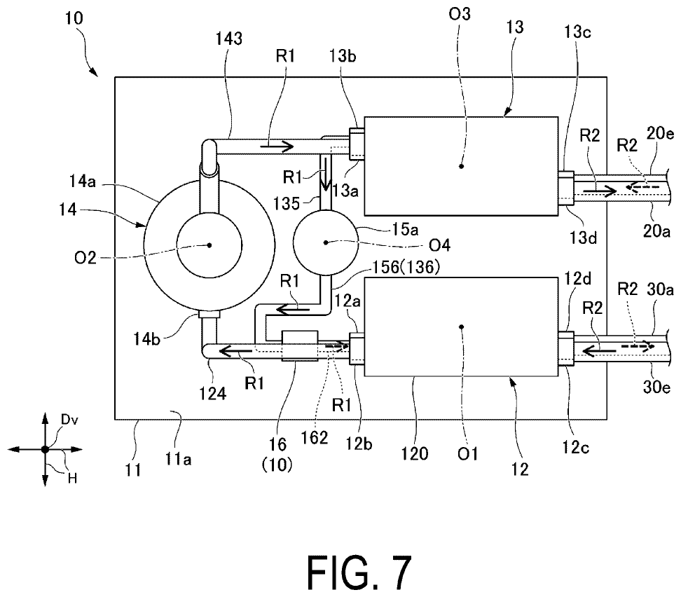

As illustrated in FIGS. 6 and 7, the receiver 15a in the present embodiment is surrounded by the evaporator 12, the compressor 14, and the condenser 13. The receiver 15a is supported by the first line 135 at a position separated from the main surface 11a of the base portion 11 around a receiver axis O4 which is a virtual axis extending from the main surface 11a in a direction coinciding with the vertical direction Dv. That is, the receiver 15a is supported such that the longitudinal direction thereof coincides with the vertical direction Dv.

### Operational Effects

In the vehicular refrigeration cycle unit 100 according to the above-described embodiment, the longitudinal direction of the receiver coincides with the longitudinal directions of the compressor, the condenser, and the evaporator, and the receiver 15a is surrounded by the compressor, the condenser, and the evaporator. Thus, in a case where these components are unitized as the refrigeration cycle 10, dead spaces are less likely to be generated, and the overall size of the refrigeration cycle 10 can be made further compact. Therefore, even in a case where the refrigeration cycle 10 includes the receiver 15a, an increase in a space occupied by the refrigeration cycle 10 can be suppressed.

### Other Embodiments

Embodiments of the present disclosure have been described above in detail with reference to the drawings. However, specific configurations are not limited to the configurations of the embodiments. Any configuration can be added, omitted, substituted, or otherwise modified, as long as such addition, omission, substitution, or modification does not depart from the scope of the present disclosure. Furthermore, the present disclosure is not to be considered as being limited by the embodiments and is only limited by the scope of the appended claims.

In the embodiments, the configuration in which the vehicular air conditioning device 1 performs the heating operation has been described as an example. However, the configuration is not limited to the heating operation, and the vehicular refrigeration cycle unit 100 may employ a configuration similar to the configuration of the above-described embodiments even in the case where a cooling operation is performed.

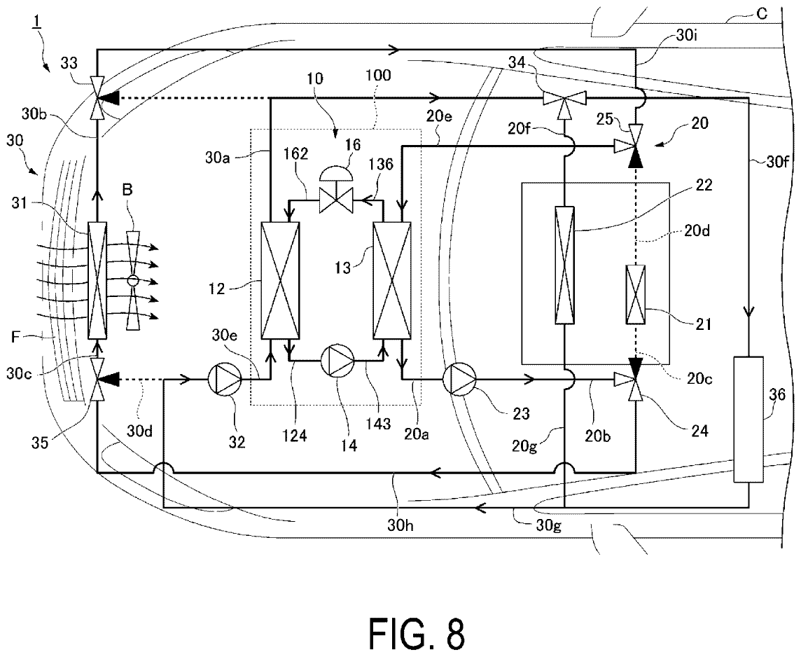

Hereinafter, configurations of the vehicle-interior heat medium circuit 20 and the vehicle-exterior heat medium circuit 30 during the cooling operation will be described with reference to FIG. 8.

The first pump 23 pumps the secondary refrigerant R2 condensed by the condenser 13 to the vehicle-exterior heat exchanger 31. The first heat medium line 20a serving as a flow path for suctioning the secondary refrigerant R2 into the first pump 23 connects the condenser 13 and the first pump 23.

The second heat medium line 20b serving as a flow path for discharging the secondary refrigerant R2 from the first pump 23 toward the vehicle-exterior heat exchanger 31 connects the first pump 23 and the first valve 24. The first valve 24 causes the secondary refrigerant R2 discharged from the first pump 23 to flow to the fourth connection line 30i without flowing to the third heat medium line 20c. The secondary refrigerant R2 having flowed in the fourth connection line 30i flows into the third valve 33.

Here, the third valve 33 causes the secondary refrigerant R2 having flowed in from the fourth connection line 30i to flow to the tenth heat medium line 30c without flowing to the eleventh heat medium line 30d. The secondary refrigerant R2 having flowed in the tenth heat medium line 30c flows into the vehicle-exterior heat exchanger 31.

The secondary refrigerant R2 having passed through the vehicle-exterior heat exchanger 31 flows into the fourth valve 34 through the ninth heat medium line 30b. Thus, a flow direction of the secondary refrigerant R2 flowing through the tenth heat medium line 30c, the vehicle-exterior heat exchanger 31, and the ninth heat medium line 30b during the cooling operation of the vehicular air conditioning device 1 is opposite to a flow direction of the secondary refrigerant R2 during the heating operation.

Here, the fourth valve 34 causes the secondary refrigerant R2 having flowed in from the ninth heat medium line 30b to flow to the third connection line 30h without flowing to the eighth heat medium line 30a. The secondary refrigerant R2 having flowed in the third connection line 30h flows into the second valve 25.

The second valve 25 causes the secondary refrigerant R2 having flowed in from the third connection line 30h to flow to the fifth heat medium line 20e without flowing to the fourth heat medium line 20d. The secondary refrigerant R2 having flowed in the fifth heat medium line 20e flows into the condenser 13.

With the configuration described above, the secondary refrigerant R2 sequentially flows through the condenser 13, the first pump 23, and the vehicle-exterior heat exchanger 31, and returns to the condenser 13. By repeating this circulation, the primary refrigerant R1 circulating in the refrigeration cycle 10 can be continuously cooled by heat exchange in the condenser 13.

The second pump 32 pumps the secondary refrigerant R2 cooled by the evaporator 12 to the cooler core 22. The secondary refrigerant R2 having passed through the evaporator 12 flows into the eighth heat medium line 30a by the suction force of the pump and then flows into the fifth valve 35. Here, the fifth valve 35 causes the secondary refrigerant R2 having flowed in from the eighth heat medium line 30a to flow to both the sixth heat medium line 20f and the first connection line 30f.

The secondary refrigerant R2 having flowed into the sixth heat medium line 20f flows into the cooler core 22. The secondary refrigerant R2 having completed heat exchange in the cooler core 22 flows into the seventh heat medium line 20g and then flows into the second connection line 30g. The secondary refrigerant R2 having flowed in the second connection line 30g flows into the eleventh heat medium line 30d, and returns to the evaporator 12 via the second pump 32 and the twelfth heat medium line 30e.

The secondary refrigerant R2 having flowed in the first connection line 30f flows into the battery cooler 36. Thus, the battery cooler 36 exchanges heat with (is cooled by) the secondary refrigerant R2 during both the heating operation and the cooling operation of the vehicular air conditioning device 1. The secondary refrigerant R2 having completed heat exchange in the battery cooler 36 flows into the second connection line 30g. The secondary refrigerant R2 having flowed in the second connection line 30g flows into the eleventh heat medium line 30d, and returns to the evaporator 12 via the second pump 32 and the twelfth heat medium line 30e.

With the configuration described above, the secondary refrigerant R2 sequentially flows through the evaporator 12, the cooler core 22, and the second pump 32, and returns to the evaporator 12. By repeating this circulation, the cooling operation is achieved, and the temperature inside the vehicle can be continuously cooled.

In the above-described embodiments, an example in which an R290 refrigerant is used as the primary refrigerant R1 and ethylene glycol is used as the secondary refrigerant R2 has been described, but other refrigerants may be used as the primary refrigerant R1 and the secondary refrigerant R2.

In the embodiment, the compressor 14, the condenser 13, the evaporator 12, and the receiver 15a are fixed on the base portion 11 such that the longitudinal directions thereof coincide with each other. This includes not only a case where the longitudinal directions completely coincide with each other, but also a case where the longitudinal directions are slightly inclined.

In the embodiments, a configuration in which corresponding sides of a pair of the evaporator plates 121 adjacent to each other in the arrangement direction A1 and corresponding sides of the condenser plates 131 adjacent to each other in the arrangement direction A2 are sealed by brazing has been described. However, the configuration is not limited to thereto. Corresponding sides of a pair of evaporator plates 121 adjacent to each other and corresponding sides of a pair of condenser plates 131 adjacent to each other may be sealed by welding, for example.

In the embodiments, a configuration in which the base portion 11 extends in the horizontal direction H and the longitudinal directions of the compressor 14, the condenser 13, and the evaporator 12 extend in the vertical direction Dv has been described. However, the configuration is not limited thereto. For example, the base portion 11 may extend in a direction perpendicular to the horizontal direction H, and the longitudinal directions of the compressor 14, the condenser 13, and the evaporator 12 may extend in the horizontal direction H. That is, the vehicular refrigeration cycle unit 100 may be provided in a lateral direction. Thus, the compressor 14, the condenser 13, and the evaporator 12 may be fixed on the base portion 11 such that the longitudinal directions thereof coincide with each other.

In the embodiments, the base portion 11 is described as a plate having a flat plate shape, but is not limited to a plate having a flat plate shape. The base portion 11 may be, for example, a bracket formed by bending a plate-shaped member formed by cutting. In that case, the base portion 11 serving as a bracket includes the main surface 11a facing upward in the vertical direction Dv.

Note that the base portion 11 only needs to include the main surface 11a to which devices constituting a refrigerant circuit (the refrigeration cycle 10) can be fixed.

The configurations of the vehicular refrigeration cycle unit 100 in the vehicular air conditioning device 1 described in the embodiments are not limited to the configurations independent from each other, and the vehicular refrigeration cycle unit 100 may be configured by appropriately combining the components described in the respective embodiments.

### Supplementary Notes

The vehicular refrigeration cycle unit described in each embodiment is understood as follows, for example.
(1) A vehicular refrigeration cycle unit 100 according to a first aspect is a vehicular refrigeration cycle unit 100 interposed between a vehicle-exterior heat exchanger 31 and a vehicle-interior heat exchanger and configured to exchange heat between secondary refrigerants R2 respectively flowing through the vehicle-exterior heat exchanger 31 and the vehicle-interior heat exchanger, the vehicular refrigeration cycle unit 100 including a base portion 11 and a refrigeration cycle 10 fixed to a main surface 11a of the base portion 11, the refrigeration cycle 10 including a compressor 14, a condenser 13, an expansion valve 16, and an evaporator 12 connected sequentially by pipes through which a primary refrigerant R1 flows, and the compressor 14, the condenser 13, and the evaporator 12 being fixed on the base portion 11 such that the longitudinal directions thereof coincide with each other.

Thus, in a case where these components are unitized as the refrigeration cycle 10, dead spaces are less likely to be generated, and the overall size of the refrigeration cycle 10 can be made compact. In addition, since the refrigeration cycle 10 is integrated by the base portion 11 and the pipes, even when an excitation force is generated at the compressor 14, the exciting force can be dispersed to the entire refrigeration cycle 10 without being unevenly distributed in the refrigeration cycle 10.
(2) A vehicular refrigeration cycle unit 100 according to a second aspect is the vehicular refrigeration cycle unit 100 according to (1), wherein the base portion 11 may extend in a horizontal direction H such that the main surface 11a faces upward, and the longitudinal directions of the compressor 14, the condenser 13, and the evaporator 12 may extend in a vertical direction Dv.

Accordingly, since the compressor 14, the condenser 13, and the evaporator 12 can receive a force of gravity in the longitudinal directions, a moment is less likely to be applied thereto. In addition, an area required for installing the refrigeration cycle 10 on the main surface 11a of the base portion 11 can be reduced.
(3) A vehicular refrigeration cycle unit 100 according to a third aspect is the vehicular refrigeration cycle unit 100 according to (1) or (2), wherein the base portion 11 may extend in a horizontal direction H such that the main surface 11a faces upward, and the compressor 14 may be provided such that a rotor shaft of the compressor 14 extends in a vertical direction Dv.

Accordingly, since the compressor 14 can receive a force of gravity in the longitudinal direction, a moment is less likely to be applied thereto. In addition, an area required for installing the refrigeration cycle 10 on the main surface 11a of the base portion 11 can be reduced.
(4) A vehicular refrigeration cycle unit 100 according to a fourth aspect is the vehicular refrigeration cycle unit 100 according to (2) or (3), wherein the condenser 13 and the evaporator 12 are plate-type heat exchangers in which heat exchange flow paths 122a, 122b, 132a, and 132b extending in the vertical direction Dv are arranged in the horizontal direction H.

Accordingly, the primary refrigerant R1 evaporated in the heat exchange flow path 122a of the evaporator 12 can be guided to an upper side in the vertical direction Dv, and the primary refrigerant R1 condensed in the heat exchange flow path 132a of the condenser 13 can be guided to a lower side in the vertical direction Dv.
(5) A vehicular refrigeration cycle unit 100 according to a fifth aspect is the vehicular refrigeration cycle unit 100 according to any one of (1) to (4), wherein the refrigeration cycle 10 may further include a receiver 15a configured to separate the primary refrigerant R1 having passed through the condenser 13 into a gas-phase portion and a liquid-phase portion and supply only the gas-phase portion of the primary refrigerant R1 to the expansion valve 16, the receiver 15a may be surrounded by the compressor 14, the condenser 13, and the evaporator 12, and a longitudinal direction of the receiver 15a may coincide with longitudinal directions of the compressor 14, the condenser 13, and the evaporator 12.

Accordingly, in a case where the compressor 14, the condenser 13, the evaporator 12, and the receiver 15a are unitized as the refrigeration cycle 10, dead spaces are less likely to be generated, and the overall size of the refrigeration cycle 10 can be made further compact.

### INDUSTRIAL APPLICABILITY

According to the present disclosure, a vehicular refrigeration cycle unit that can suppress an increase in a space occupied by a refrigeration cycle can be provided.

### REFERENCE SIGNS LIST

1 Vehicular air conditioning device, 10 Refrigeration cycle, 11 Base portion, 11a Main surface, 12 Evaporator, 12a, 13a Primary refrigerant inlet section, 12b, 13b Primary refrigerant outlet section, 12c, 13c Secondary refrigerant inlet section, 12d, 13d Secondary refrigerant outlet section, 13 Condenser, 14 Compressor, 14a Compressor casing, 14b Suction port, 14c Discharge port, 15, 15a Receiver, 16 Expansion valve, 20 Vehicle-interior heat medium circuit, 20a First heat medium line, 20b Second heat medium line, 20c Third heat medium line, 20d Fourth heat medium line, 20e Fifth heat medium line, 20 f Sixth heat medium line, 20g Seventh heat medium line, 21 Heater core, 22 Cooler core, 23 First pump, 24 First valve, 25 Second valve, 30 Vehicle-exterior heat medium circuit, 30a Eighth heat medium line, 30b Ninth heat medium line, 30c Tenth heat medium line, 30d Eleventh heat medium line, 30 e Twelfth heat medium line, 30 f First connection line, 30g Second connection line, 30h Third connection line, 30i Fourth connection line, 31 Vehicle-exterior heat exchanger, 32 Second pump, 33 Third valve, 34 Fourth valve, 35 Fifth valve, 36 Battery cooler, 100 Vehicular refrigeration cycle unit, 120, 130 Heat exchanging unit, 121 Evaporator plate, 122a, 122b, 132a, 132b Heat exchange flow path, 124 Suction line, 131 Condenser plate, 135 First line, 136 Pre-expansion line, 143 Discharge line, 156 Second line, 162 Post-expansion line, A1, A2 Arrangement direction, B Blower, C Vehicle body, Dv Vertical direction, F Front grille, H Horizontal direction, O1 Evaporator axis, O2 Compressor axis, O3 Condenser axis, O4 Receiver axis, R1 Primary refrigerant, R2 Secondary refrigerant

1. A vehicular refrigeration cycle unit interposed between a vehicle-exterior heat exchanger and a vehicle-interior heat exchanger and configured to exchange heat between secondary refrigerants respectively flowing through the vehicle-exterior heat exchanger and the vehicle-interior heat exchanger, the vehicular refrigeration cycle unit comprising:
a base portion; and
a refrigeration cycle fixed to a main surface of the base portion, the refrigeration cycle including a compressor, a condenser, an expansion valve, and an evaporator connected sequentially by pipes through which a primary refrigerant flows, the compressor, the condenser, and the evaporator being fixed on the base portion such that longitudinal directions of the compressor, the condenser, and the evaporator coincide with each other.

2. The vehicular refrigeration cycle unit according to claim 1, wherein
the base portion extends in a horizontal direction such that the main surface faces upward, and
the longitudinal directions of the compressor, the condenser, and the evaporator extend in a vertical direction.

3. The vehicular refrigeration cycle unit according to claim 1, wherein
the base portion extends in a horizontal direction such that the main surface faces upward, and
the compressor is provided such that a rotor shaft of the compressor extends in a vertical direction.

4. The vehicular refrigeration cycle unit according to claim 2, wherein the condenser and the evaporator are plate-type heat exchangers in which heat exchange flow paths extending in the vertical direction are arranged in the horizontal direction.

5. The vehicular refrigeration cycle unit according to claim 1, wherein
the refrigeration cycle further includes a receiver configured to separate the primary refrigerant having passed through the condenser into a gas-phase portion and a liquid-phase portion and supply only the liquid-phase portion of the primary refrigerant to the expansion valve,
the receiver is surrounded by the compressor, the condenser, and the evaporator, and
a longitudinal direction of the receiver coincides with longitudinal directions of the compressor, the condenser, and the evaporator.

6. The vehicular refrigeration cycle unit according to claim 2, wherein
the base portion extends in a horizontal direction such that the main surface faces upward, and
the compressor is provided such that a rotor shaft of the compressor extends in a vertical direction.

7. The vehicular refrigeration cycle unit according to claim 6, wherein the condenser and the evaporator are plate-type heat exchangers in which heat exchange flow paths extending in the vertical direction are arranged in the horizontal direction.
